(19) United States
(12) Patent Application Publication
(10) Pub. No.: US 2004/0091189 A1
(43) Pub. Date: May 13, 2004

(54) Purely rolling bearing

(76) Inventors: Dabang Yu, Shanghai (CN); Daxi Yu, Shanghai (CN)

Correspondence Address: BRIGGS AND MORGAN, P.A., 2400 IDS CENTER, MINNEAPOLIS, MN, 55402, US

(21) Appl. No.: 10/300,390

(22) Filed: Nov. 19, 2002

Related U.S. Application Data
(63) Continuation-in-part of application No. 09/763,253, filed on Apr. 12, 2001, now abandoned.

(30) Foreign Application Priority Data
Aug. 21, 1998 (CN) 98224923.3
Jul. 8, 1999 (WO) PCT/CN99/00088

(51) Int. Cl. F16C 19/20; F16C 33/37; F16C 19/40

(52) U.S. Cl. 384/522; 384/553

(57) ABSTRACT

The present invention relates to a purely rolling bearing without cage member and sliding friction, comprising an inner race ring, an outer race ring, a number of rolling members provided between the inner and outer race rings, a number of positioning rolling members and two positioning rings. Every positioning rolling member is provided between two adjacent rolling members and contact therewith. The positioning rings are positioned on the slide way at two ends of the said positioning rolling members and keep rolling contact therewith.

### FIELD OF THE INVENTION

This invention relates to a rolling bearing, particularly to such a purely rolling bearing without sliding friction.

### BACKGROUND OF THE INVENTION

This application is a continuation-in-part of U.S. patent application Ser. No. 09/763,253, filed Feb. 20, 2001.

The usual rolling bearing comprises an inner race ring and an outer race ring, a number of rolling members and a retainer. The retainer is provided in the bearing for the rolling members to locate each other and for the relative location of the rolling bodies in the bearing. The rolling members are restricted at high speed by the said retainer because of sliding friction, no matter what structure or what material and smooth finish. The sliding friction resistance influences seriously the properties and life of a bearing.

The relative sliding friction between the rolling members and retainer will cause a series of problems while the bearing is running, especially at high speed, such as it is difficult to be lubricated, the temperature rising increases, the noise is heightened. Under the conditions of high temperature and high speed, the stress will increase suddenly which results in ruin of the bearing. The rolling friction resistance in a bearing is not worth mentioning compared with the sliding friction resistance. The existing of the sliding friction causes that the load capacity of the rolling bearing is obviously reduced and the energy loss is remarkable. At high speed, the sliding friction force produced by the action of the centrifugal force between the rolling members and the retainer will increase notably. The friction stress concentration will bring about the ruin of the bearing rapidly. Consequently, the raise of the limited speed of the rolling bearing is confined with the sliding friction.

U.S. Pat. No. 3,124,396 discloses a kind of rolling bearing, which uses rolling separators similar to cylinder instead of the retainer, and uses retaining rings to hold and retain the related rolling separators, so that the bearing could become a positive rolling bearing. But, the retaining ring comprises an outer ring, an inner split spring ring and a wire locking ring, therefore, the structure of the bearing is complicated, the cost is higher and the assembly is more difficult. Besides the foregoing problems, the inner split spring ring is provided with a scarf. There must be a crack, namely there is distance between the opposite ends. When any one of the rolling balls arrives at the crack, the vibration, disturbance and wear will come out. In addition, the friction between the retaining rings and the two opposite ends of any one of the rolling separators are still sliding friction, which influence the properties of the rolling bearing. Besides that, the center of gravity of the split ring doesn't coincide with the geometric center, which also produces unstable movement, because of the crack.

According to the specification and its attached figures of the US invention. Each rolling separators is necked or provided at its center with an annular groove 29 which is circular in cross section and ground to a close tolerance to conform to the balls 20. (from No. 53-55) It is easy to prove that the contact of conformation between the ball and the rolling separator produces impossibly pure roll. Furthermore, the friction between the split ring and rolling separators still includes sliding friction and such a structure can be sustained to become invalid for little time.

European Patent Publication No. 0,264,264 revealed another kind of rolling bearing, which provides a roller (that is a rolling retainer member) similar to a cylinder to replace the usual retainer. The rollers are assembled and sustained by using of location rings. But, the location rings of the rolling bearing must comprise two free ring members 5 and two supporting rails 6a which are used to sustain the location rolling bodies along the opposite radial directions, respectively because any one of the rollers is arranged to insure its axis to be located on the center of the connecting line between the two adjacent rolling ball centers. (See FIG. 2, FIG. 8 or FIG. 9 of the referenced patent). Therefore, its structure is complicated, its cost is high and the assembly is difficult. In addition, the friction between the location rings and the two opposite ends of the rollers is still sliding friction, which influence the properties of the bearing.

Besides the above, the contact between the cylinder positioning rolling member (roller) and the rolling member (ball) is the contact of the two sections of circular in two patents as mentioned above. If the arc curvature radius of the positioning rolling member is larger than the curvature radius of the rolling member, the contact is single point contact, then which makes the rolling members incline and be unstable. If the arc curvature radius of the positioning rolling member is less than the curvature radius of the rolling member, the contact is a two point contact, thus causing the rolling bodies wear and tear easily, and lose efficacy at last.

### SUMMARY OF THE INVENTION

The object of the invention is to provide a purely rolling bearing, which is in a simple structure and is easy to be assembled.

In order to realize the above object, the invention provides a purely rolling bearing which comprises an inner race ring, an outer race ring, a number of rolling members between the inner race ring and the outer race ring, positioning rolling members arranged in alternation with the rolling members and kept in rolling contact with the balls, and a positioning ring arranged on the race ways of the two ends of the positioning rolling members, wherein, the axis of any related positioning rolling member is located at one side of the line connecting the centers of the two adjacent rolling members, and the related positioning rings are all made up of unitary part, and in the rolling contact with the raceways.

Further, the axis of any aid positioning rolling members is located between the line connecting the centers of the two adjacent rolling members and the outer race ring or the inner race ring.

The invention is put forward as follows:

Each positioning rolling member is assembled between the two adjacent rolling members. The positioning rolling members insure simultaneously uniform circumferential spacing of the adjacent rolling members and confine the rolling members to axial location in the bearing. The axial and radial location of the positioning rolling members are restricted by the positioning rings on the raceways of the two opposite ends of the positioning rolling members. The contacts between the positioning rings and any raceway of the positioning rolling members are point contacts, and so are the point contacts between any one of the positioning rolling member and the adjacent rolling member. The movements of the positioning rolling members include a self-rotation and a revolution round the axis of the bearing. The relative velocity difference between a contact point on any one of the location rolling bodies and the contact point on the rolling body contacted, both of which coincide each other, is zero, and so is the relative velocity difference between a contact point on either of the location rings and the contact point on the location rolling body contacted, both of which coincide each other. Therefore, those movements of the contact points all belong to purely rolling movements. There is not any relatively sliding friction. The bearing is a purely rolling bearing, which name matches reality. The assembly and production of the bearing of the invention are easy, in order to keep the rolling members and the positioning rolling members running steadily, it is necessary only to provide a positioning ring at the opposite side of the line connecting the centers of the two adjacent rolling members, for example, one side near to the outer race ring or one side near to the inner race ring, the positioning right is assembled to contact with the positioning rolling members. In comparison with the referenced patent (European patent publication No. 0,264,264), it can be seen that there is no need to arrange two covers, and especially there is no trouble of providing support rail on said covers, so the invention could be extended and applied easily and widely.

The following will further describe in detail the invention in combination with a preferred embodiment together with the figures attached.

### BRIEF DESCRIPTION OF THE DRAWINGS

FIG. 1 is the radial section view of a rolling bearing of the invention;

FIG. 2 is a schematic view showing the first preferred embodiment of arrangement and fitting relationship between the positioning rolling members and the rolling members of the present invention;

FIG. 3 is a schematic view showing the second preferred embodiment of arrangement and fitting relationship between the positioning rolling members and the rolling members of the present invention.

### DETAILED DESCRIPTION OF THE PREFERRED EMBODIMENTS

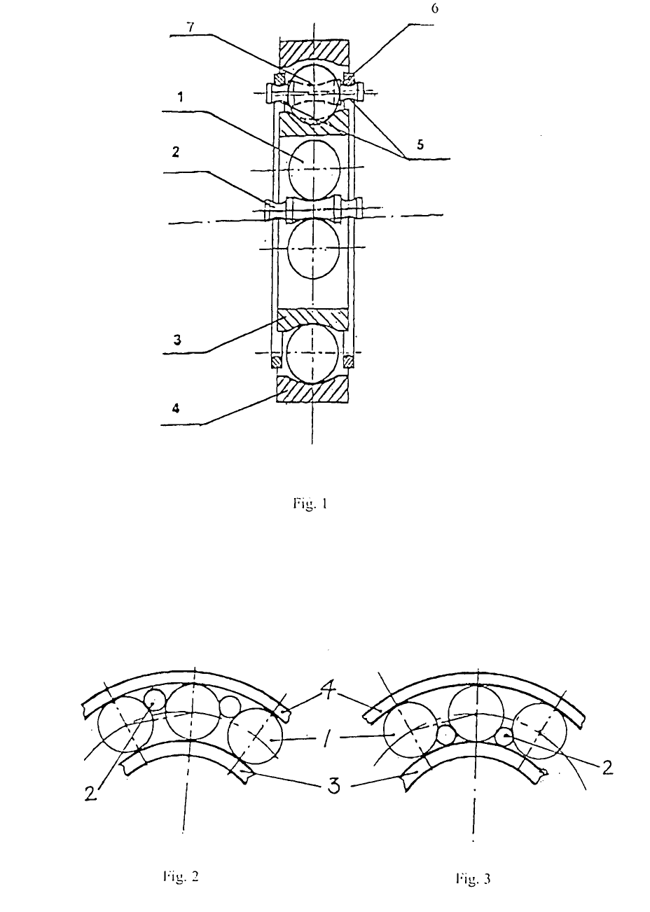

Referring to FIG. 1-FIG. 3, each positioning rolling member 2 is assembled between two adjacent rolling members 1 and along the circumferential direction. The positioning rolling members 2 insure simultaneously uniform circumferential spacing between two adjacent rolling members 1 and confine the rolling members 1 to the axial location in the bearing. The axial location and radial location of the positioning rolling members 2 are performed by positioning rings 6 on the raceways 5, which is a circular arc in cross section, of two opposite ends of the positioning rolling members 2. It can be seen from FIG. 2 and FIG. 3 that the axis of the positioning rolling members 2 is lying at one side of the line connecting the centers of the two adjacent rolling members 1. What FIG. 2 shows lies at one side near to the outer ring 4 and what FIG. 3 shows lies at one side near to the inner race ring 3. The contacts between either of the location rings 6 and any one of the raceways 5, any one of the location rolling bodies 2 and the rolling body 1 contacted and any one of the rolling bodies 1 and the inner race ring 3 or the outer race ring 4 of the bearing are all point contacts, and the relative velocity differences between any two points contacted with each other are all zero. Therefore the bearing is a purely rolling bearing.

The cross section of the raceway 5 is concave shape, the cross section of the positioning ring 6 is a convex shape, so that they form a rolling contact. On the contrary, let the cross section of the raceway 5 be a convex shape and the cross section of the positioning ring 6 be a concave shape, it is feasible too. In addition, the cross section of the raceway 5 and the central raceway 7 of any of the positioning rolling member 2 contacted with the rolling member 1 may be V-shaped, circular-arc-shaped or notch-shaped, and so on. The cross sections of the raceway of the inner race ring 3 and the outer race ring 4 may also be V-shaped, circular-arc-shaped or notch-shaped, and so on.

The positioning rolling member 2 may be made into parted parts, for the convenience of the assembly and production. That is, the two parts which form the two opposite end raceways 5 and the part which forms the central raceway 7 may be produced separately first, then be fixed through the tight fit or screw fit and so on. Of cause, the positioning rolling member 2 may be made into a single part.

A variety of equivalent variations may be made by the technicians familiar with the technical realm on the basic of the invention, although the invention has been described above combined with a preferred embodiment. Therefore, the scope of the invention should be defined by the claims.

The present invention may be embodied in other specific forms without departing from the spirit or essential attributes thereof, and it is therefore desired that the present embodiment be considered in all respects as illustrative and not restrictive, reference being made to the appended claims rather than to the foregoing description to indicate the scope of the invention.

What is claimed is:

1. A purely rolling bearing comprises an inner race ring (3), an outer race ring (4), a number of rolling members (1) between the inner race ring (3) and the outer race ring (4), positioning rolling members (2) provided in alternation with the rolling members (1) and kept in the rolling contact, and two positioning rings (6) provided on the race ways (5) of the two ends of the positioning rolling members (2), what characterized is that the axis of any related positioning rolling members (2) is located at one side of the line connecting the centers of the two adjacent rolling members (1) and that the related positioning rings (6) rolling on the raceways (5) are all single location rings.

2. The bearing of claim 1, wherein the axis of any the said positioning rolling members (2) is located between the line connecting the centers of the two adjacent rolling members (1) and the outer race ring (4).

3. The bearing of claim 1, wherein the axis of any said positioning rolling members (2) is located between the line connecting the centers of the two adjacent rolling members (1) and the inner race ring (3).

4. The bearing of claim 1, wherein the cross sections of the two opposite ends of any one of the said positioning rolling members (2) may be in concave shape or convex shape.

5. The bearing of claim 1, wherein the cross sections of the said positioning rings (6) may be made into concave shape or convex shape, so that they matches the raceways (5) of the positioning rolling members (2) and roll on them.

6. The bearing of claim 4, wherein the cross sections of the raceways (5) of the two opposite ends of any one of the said positioning rolling members (2) and of the central raceway (7) of any one of the said positioning rolling members (2) rolling on the rolling members (1) may be V-shaped, circular-shaped or notch-shaped.

7. The bearing of claim 1, wherein the cross sections of the race ways of the said inner race ring (3) and outer race ring (4) may be V-shaped, circular-arc-shaped or notch-shaped.
